(19) United States
(12) Patent Application Publication
(10) Pub. No.: US 2009/0124762 A1
(43) Pub. Date: May 14, 2009

(54) Methods and systems for the selective formation of thiourethane bonds and compounds formed therefrom

(76) Inventors: Chad W. Brown, Bartlesville, OK (US); Mitchell D. Refvik, Bartlesville, OK (US); Jim D. Byers, Bartlesville, OK (US); Roger A. Patton, Bartlesville, OK (US)

Correspondence Address: FLETCHER YODER (CHEVRON PHILLIPS), P. O. BOX 692289, HOUSTON, TX, 77069, US

(21) Appl. No.: 11/983,388

(22) Filed: Nov. 8, 2007

(51) Int. Cl. C08G 18/28

(52) U.S. Cl. 525/418; 525/452; 528/52; 528/65; 528/55

(57) ABSTRACT

The present techniques relate to thiourethane compositions formed by reacting a reactive composition containing active molecules having an average of at least one thiol group per active molecule and an average of at least one hydroxyl group per active molecule with a monomer composition containing monomer molecules having an average of at least two isocyanate groups per monomer molecule. The reactions are performed in the presence of an amine catalyst, which may preferentially react thiol groups over hydroxyl groups, thus forming a thiourethane composition having, on average, more hydroxyl groups than thiol groups and more thiourethane groups than urethane groups, on a normalized basis.

### BACKGROUND OF THE INVENTION

The present techniques generally relate to thiourethane compositions made from reactions of compositions containing compounds having thiol and hydroxyl groups with compositions containing compounds having isocyanate groups. Generally, the techniques related to methods for selectively forming thiourethane groups from compositions having isocyanate groups and compositions having thiol and hydroxyl groups. The present techniques also provide methods and catalysts for selectively forming thiourethane groups in compounds containing both thiol and hydroxyl groups.

This section is intended to introduce the reader to aspects of art that may be related to aspects of the present techniques, which are described and/or claimed below. This discussion is believed to be helpful in providing the reader with background information to facilitate a better understanding of the various aspects of the present techniques. Accordingly, it should be understood that these statements are to be read in this light, and not as admissions of prior art.

As chemical and petrochemical technologies have advanced, the products of these technologies have become increasingly prevalent in society. In particular, as techniques for bonding simple molecular building blocks into longer chains, termed polymers, have advanced, the polymer products, typically in the form of various plastics, have been increasingly incorporated into various everyday items. For example, polyurethane polymers and copolymers, made from the reactions of compounds containing hydroxyl groups with compounds containing isocyanate groups, may be used in retail and pharmaceutical packaging, furniture, household items, automobile components, adhesives, coatings, and various other consumer and industrial products.

The chemical industry strives to make these products with low-cost feedstocks that are in abundant supply. Currently, the main feedstocks for polyurethanes, and other plastics, are petrochemicals isolated from petroleum. However, as fossil fuels deplete over time, alternative sources are being sought as replacements for feedstocks. Further, the chemical industry continuously strives to produce products and use feedstocks that are environmentally friendly.

### BRIEF DESCRIPTION OF THE FIGURES

Advantages of the techniques may become apparent upon reading the following detailed description and upon reference to the drawings in which:

FIG. 1 is an infrared spectrum of the reaction or contact product of a composition containing both thiol and hydroxyl groups with a composition containing isocyanate groups;

FIG. 2 is a plot of a reaction curve illustrating the increase in absorbance over time of a carbonyl in a urethane group during the reaction of 1-hydroxy-2-mercaptocyclohexane and n-butyl isocyanate using a tin catalyst;

FIG. 3 is a plot of a reaction curve illustrating the increase in absorbance over time of a carbonyl in a thiourethane group during the reaction of mercapto hydroxy cyclohexane and n-butyl isocyanate using a tin catalyst;

FIG. 4 is a plot of a reaction curve illustrating the increase in absorbance over time of a carbonyl in a urethane group during the reaction of mercapto hydroxy cyclohexane and n-butyl isocyanate using an amine catalyst, in accordance with an embodiment of the present techniques; and

FIG. 5 is a plot of a reaction curve illustrating the increase in absorbance over time of a carbonyl in a thiourethane group during the reaction of mercapto hydroxy cyclohexane and n-butyl isocyanate using an amine catalyst, in accordance with an embodiment of the present techniques.

### DETAILED DESCRIPTION OF SPECIFIC EMBODIMENTS

One or more specific embodiments of the present techniques will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

One potential source of alternative feedstocks for polymers is natural source oils, for example, oils isolated from soybeans, corn, or other vegetable or animal sources. These oils may provide a renewable source of raw materials for the production of numerous materials currently made from fossil fuels. Accordingly, research has focused on effectively utilizing these natural feedstocks in various polymers.

For example, natural source oils include unsaturated esters that may be reacted with different chemical compounds to form reactive groups that may be used in further reactions. For example, unsaturated esters may be reacted with hydrogen sulfide to form thiol groups along the carbon chains. In another example, the unsaturated esters may be initially reacted with oxygen containing groups to form epoxy groups. These epoxidized oils may then be reacted with hydrogen sulfide to form molecules having both thiol groups and hydroxyl groups along the carbon chain. Such reactions are not limited to natural source oils, as any number of carbon compounds containing one or more carbon-carbon double bonds may be used to form these molecules. The compounds containing thiol groups and hydroxyl groups may then be reacted with isocyanate groups to form compositions containing thiourethane and/or urethane groups.

### Overview

The present techniques are directed to thiourethane compositions that include the contact product of reactive compositions containing active molecules having hydroxyl and thiol groups with monomer compositions containing monomer molecules having isocyanate groups. The thiourethane compositions formed as the contact product may include the contacted compounds, reaction products formed from the contacted compounds, or both, in addition to other ingredients, as discussed below. Generally, these types of reactions may be initiated by water, for example, in moisture cured adhesives, or with amine or metal catalysts. In the present techniques, the appropriate selection of an amine catalyst may be used to influence the preferential reaction of thiol groups with isocyanate groups. This preferential reaction may result in a thiourethane composition having free hydroxyl groups. The free hydroxyl groups may then be available for further reactions with additional compositions containing, for example, isocyanate groups, epoxy groups, or acid groups, among others. The thiourethane composition may include numerous different thiourethane molecules having hydroxyl and/or thiol groups, depending on the reaction statistics. Furthermore, the thiourethane compositions may include other materials, such as fillers, solvents, property modifying agents, or other components, or any combination thereof.

For example, embodiments of the present techniques may be used to form polymers, prepolymers, or other thiourethane compositions having thiourethane groups and a normalized average number of hydroxyl groups greater than a normalized average number of thiol groups. As discussed in detail below, any number of reactive compositions containing active molecules having thiol groups, hydroxyl groups, or both, may be used to form the thiourethane compositions. For example, in various embodiments, the active molecules may include compounds having one or more thiol groups, compounds having one or more hydroxyl groups, compounds having both thiol and hydroxyl groups, mercaptanized unsaturated esters, mercaptanized epoxidized unsaturated esters, crosslinked mercaptanized unsaturated esters, or any combination thereof. The monomer composition may include aliphatic isocyanates, cyclic aliphatic isocyanates, aromatic isocyanates, or any combinations thereof. Further, the polymer composition may include property modifying agent. A solvent may also be used in producing the thiourethane composition.

The formation of thiourethane compositions having free hydroxyl groups may provide a valuable material for further reactions. For example, the free hydroxyl groups may be reacted with additional monomers to form final compositions that may be useful in coatings, adhesives, or other products. Accordingly, techniques have been developed to preferentially react thiol groups with isocyanate groups, as discussed in detail below.

### The Preferential Formation of Thiourethane Groups

Isocyanate groups, —NCO, may react with any number of groups having active hydrogens to form bonds. For example, isocyanates will generally react with hydroxyl groups, thiol groups, amine groups, amide groups, or carboxylic acid groups, among others. The reaction of hydroxyl groups (—OH) with isocyanate groups, as shown in Equation 1, generally forms urethane groups that make up the backbone of polyurethane polymers.

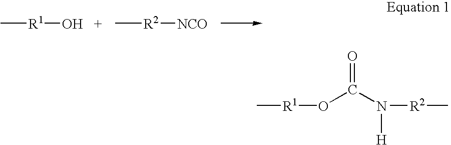

In this equation, R¹ and R² represent the chemical species to which the indicated reacting hydroxyl and isocyanate groups, respectively, are attached. R¹ may include aliphatic groups, aromatic groups, or any combination thereof, and may include other isocyanate reactive groups, such as additional hydroxyl groups and/or thiol groups, among others. R may include aliphatic groups, aromatic groups, or any combination thereof, as well as other isocyanate groups. The isocyanate groups will also react with thiol groups (—SH) to form thiourethane groups, as shown in Equation 2.

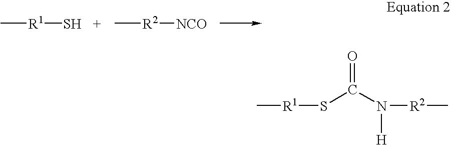

As in Equation 1, R¹ and R² represent the chemical species to which the indicated reacting thiol and isocyanate groups, respectively, are attached. R¹ may include aliphatic groups, aromatic groups, or any combination thereof, in addition to other isocyanate reactive groups, such as additional hydroxyl groups and/or thiol groups, among others. R² may include aliphatic groups, aromatic groups, or any combination thereof, in addition to other isocyanate groups.

If a reactive composition containing active molecules having both hydroxyl and thiol groups is reacted with a monomer composition containing monomer molecules having isocyanate groups, the number of each hydroxyl and thiol group that remains unbound in the final product depends on the relative reactivity of the hydroxyl and thiol groups to the isocyanate group. For example, if the thiol group reacts preferentially with the isocyanate group and the amount of isocyanate groups present is restricted, a thiourethane composition having free hydroxyl groups and thiourethane groups may be formed. In one such exemplary reaction, a mercapto hydroxy cyclohexane may be reacted with n-butyl isocyanate. If the thiol group preferentially reacts to form a thiourethane group, the resulting reaction may be as shown in Eqn 3.

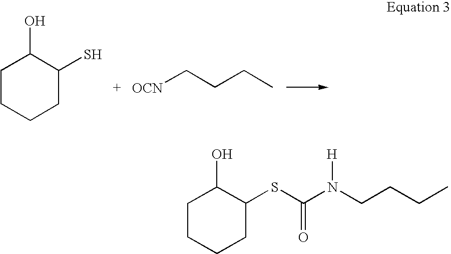

Other reactive compositions containing both thiol and hydroxyl groups may be used in embodiments of the present techniques and are discussed in detail below.

Various ratios may be useful in expressing the proportion of hydroxyl groups and thiol groups in the thiourethane molecules of the thiourethane composition. For example, one such ratio, R_{H/T}, may be calculated as the ratio of the normalized average number of free hydroxyl groups per thiourethane molecule to the normalized average number of free thiol groups per thiourethane molecule. The normalized average number of free hydroxyl groups, Hₐᵥₑ, may be calculated by dividing the average number of free hydroxyl groups per thiourethane molecule by the sum of the average number of free hydroxyl groups per thiourethane molecule and the average number of urethane groups per thiourethane molecule. Similarly, the normalized average number of free thiol groups, Tₐᵥₑ, may be calculated by dividing the average number of free thiol groups per thiourethane molecule by the sum of the free thiol groups and thiourethane groups per thiourethane molecule. The ratio R_{H/T} may be calculated by dividing these numbers, i.e., R_{H/T}=Hₐᵥₑ/Tₐᵥₑ. In some embodiments, R_{H/T} may approach infinity, i.e., no remaining thiol groups are present.

A similarly useful ratio, R_{T/U} may be used to describe the proportion of urethane groups and thiourethane groups in the thiourethane molecules of the thiourethane composition. This ratio may be calculated by determining the ratio of the normalized average number of thiourethane groups per thiourethane molecule to the normalized average number of urethane groups per thiourethane molecule. The normalized average number of urethane groups, Uₐᵥₑ, may be calculated by dividing the average number of urethane groups per thiourethane molecule by the sum of the average number of free hydroxyl groups per thiourethane molecule and the average number of urethane groups per thiourethane molecule. Similarly, the normalized average number of thiourethane groups, TUₐᵥₑ, may be calculated by dividing the average number of thiourethane groups per thiourethane molecule by the sum of the free thiol groups and thiourethane groups per thiourethane molecule. The ratio R_{T/U} may then be calculated by dividing these numbers, i.e., R_{T/U}=TUₐᵥₑ/Uₐᵥₑ. In some embodiments, R_{T/U} may approach infinity, i.e., indicating that no urethane groups are present.

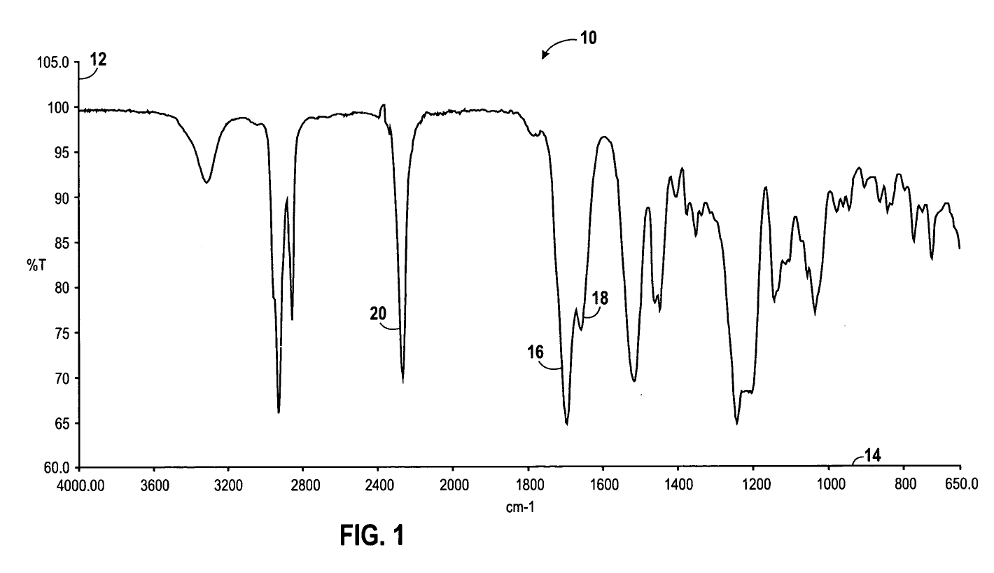

One of ordinary skill in the art will recognize that R_{H/T} and R_{T/U} may be measured using a variety of techniques. For example, the concentrations of the thiourethane and urethane groups may be determined using spectroscopic techniques such as infrared spectroscopy, Raman spectroscopy, ¹³C nuclear magnetic resonance (NMR), among others. The utility of spectroscopic techniques to follow reactions of thiol and/or hydroxyl groups with isocyanate groups may be illustrated by infrared spectrum 10 provided in the plot in FIG. 1. The infrared spectrum 10 is a plot of the % transmission (% T) 12 versus frequency of light (cm-1) 14. The infrared spectrum 10 shows the light transmission of the contact product of a mercapto hydroxy cyclohexane with hexyl isocyanate. As may be seen in the plot, the absorbance of the carbonyl bond of the urethane 16 is easily distinguished from the carbonyl bond of the thiourethane 18. Both are also easily distinguished from the carbonyl bond of the isocyanate 20. The infrared spectrum 10 of the carbonyl bonds of the urethane and thiourethane groups 16, 18 may then be used to quantify these groups, and to calculate the amount of hydroxyl and thiol groups incorporated into urethane and thiourethane groups. Thus, the amount of free thiol and hydroxyl groups remaining may also be calculated.

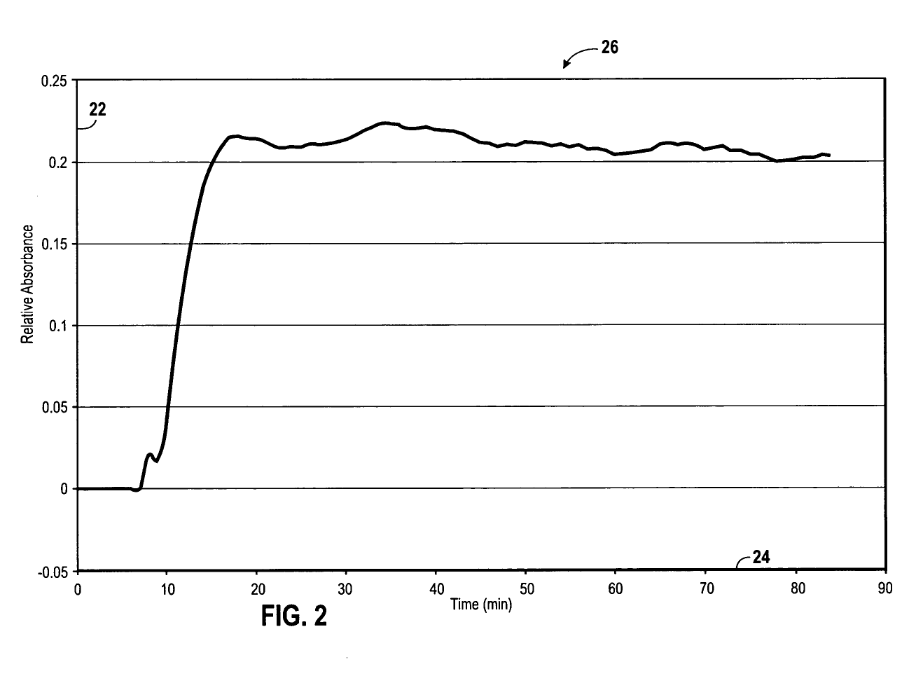

In embodiments of the present techniques, control of R_{H/T} and R_{T/U} may be obtained by selection of an appropriate catalyst or by the selection of an appropriate catalyst and controlling the ratio of isocyanate groups to active hydrogen groups, which may generally be thiol and hydroxyl groups in the present techniques. For example, the use of an amine catalyst may cause the preferential reaction of the thiol groups with the isocyanate groups over the reaction of the hydroxyl groups with the isocyanate groups. Various amine catalysts that may be used in the present techniques are discussed in detail, below. The influence an amine catalyst may have in controlling the preferential reaction of the thiol groups with the isocyanate groups may be illustrated by the plots in FIGS. 2-5.

FIGS. 2-5 are plots showing the change in relative absorbance 22 over time 24 during the reaction of mercapto hydroxy cyclohexane with n-butyl isocyanate in the presence of two different catalysts. For all of these plots, the catalyst was added at six minutes. Further details of the reactions are discussed in the experimental section, below. The absorbance curves charted in these plots correspond to the amount of the various species present and, thus, the slope of the plots corresponds to the reaction rates.

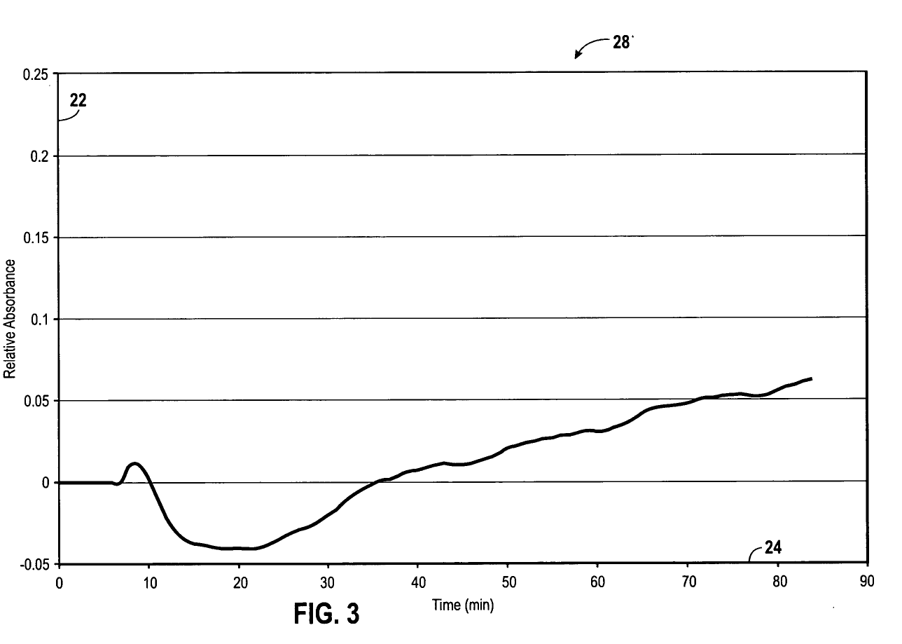

The first catalyst, used to generate the absorbance curves 26, 28 seen in FIGS. 2 and 3, was dibutyl tin dilaurate (DBTDL) at 30° C. The absorbance curve 26 in the plot of FIG. 2 shows the change in relative absorbance 22 over time (min) 24 at the maximum of the carbonyl peak in the urethane group 16. As seen from the sharp increase in absorbance curve 26, the urethane group is forming at a relatively high rate. In contrast, the absorbance curve 28 in the plot of FIG. 3 was taken at the maximum of the carbonyl peak of the thiourethane group 18. Although a slight initial negative shift in the baseline is present, the overall increase in the absorbance curve 28 shows a slow formation of a thiourethane group. As can be seen from the comparison of the shallow slope of the absorbance curve 28 in FIG. 3 to the sharply increasing slope of the absorbance curve 22 in FIG. 2, it can be seen that formation of urethane groups is faster than the formation of thiourethane groups in the presence of the tin catalyst. Comparison of the absorbance curves 26, 28 in FIGS. 2 and 3 indicate shows the steady formation of the thiourethane group after a significant percentage of the urethane groups have formed. Accordingly, if the isocyanate concentration were limited, this would preferentially increase the number of urethane groups and leave more thiol groups free in the final composition.

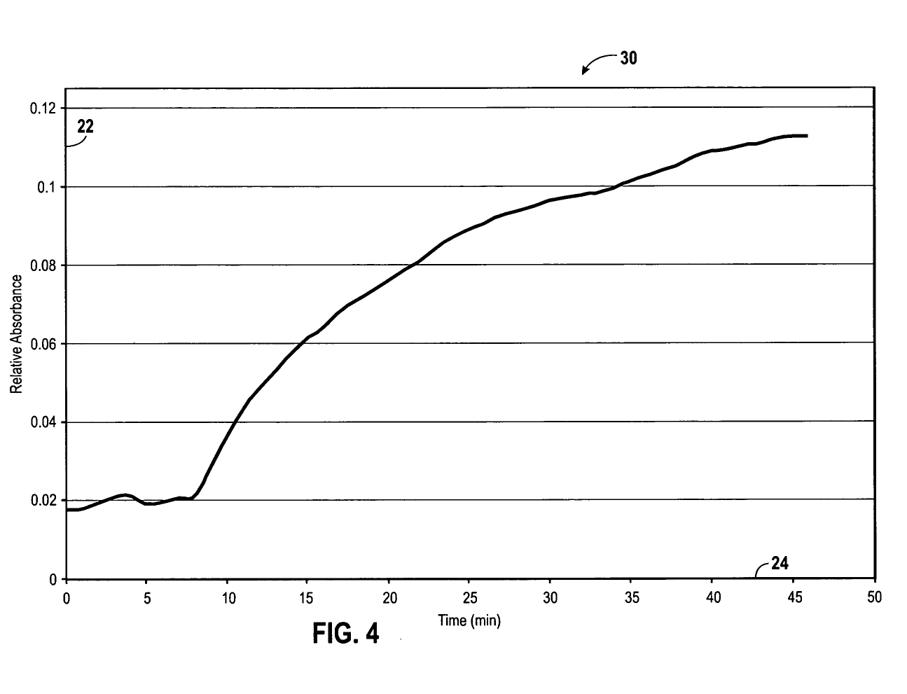

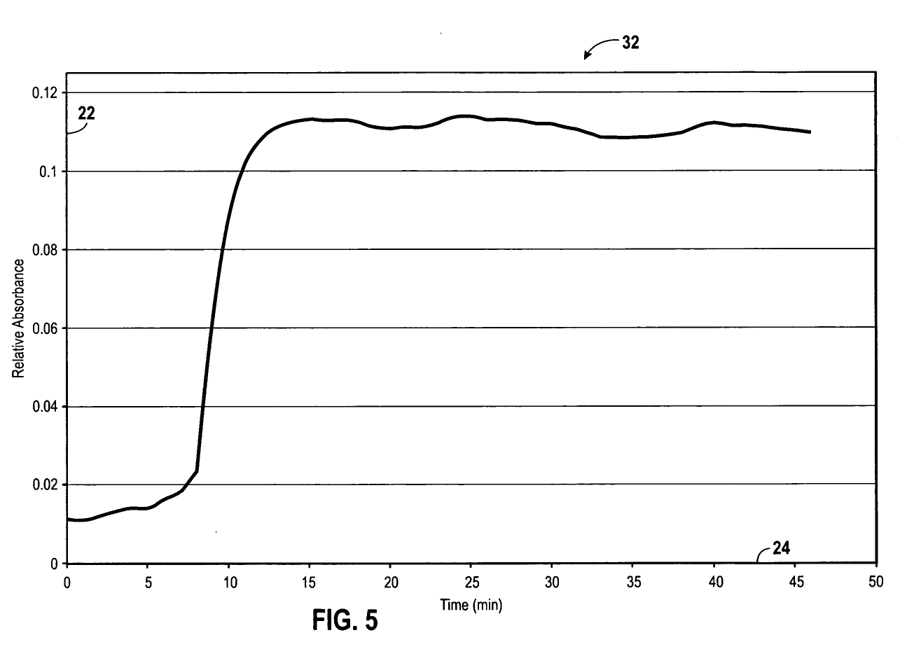

The absorbance curves 26, 28 discussed above may be compared to the absorbance curves 30, 32 shown in the plots of FIGS. 3 and 4, which were run in presence of triethyl amine (TEA) at 60° C. As for FIG. 2, the absorbance curve 30 in the plot of FIG. 4 was measured at the maximum of the carbonyl peak in the urethane group 16. The steady increase in the absorbance curve 30 of FIG. 4 shows a steady formation of urethane groups. In comparison, the absorbance curve 32 in the plot of FIG. 5 was taken at the maximum of the carbonyl peak of the thiourethane group 18. As is apparent from the steep slope of the absorbance curve 32, the formation of the thiourethane group is faster than the formation of urethane groups in the presence of amine catalysts. Comparison of the absorbance curves in FIGS. 4 and 5 indicate shows the steady formation of the urethane group after a significant percentage of the thiourethane groups have formed. If the isocyanate concentration were limited, the number of thiourethane groups would typically be higher, leaving more hydroxyl groups free in the final composition.

Further control of the thiourethane composition may be achieved by adjusting the ratio of the number of isocyanate groups to number of active hydrogen groups, allowing the production of a material having thiourethane groups and a desired quantity of free hydroxyl groups. For example, in embodiments, the isocyanate groups may be limited to 1 isocyanate group per active hydrogen group, to 0.5 isocyanate groups per active hydrogen group, to 0.25 isocyanate groups per active hydrogen group, to 0.1 isocyanate groups per active hydrogen group, or to any value in between. In other embodiments, the isocyanate groups may range from 0.8 to 1.2 isocyanate groups per active thiol group, or range from 0.9 to 1.1 isocyanate groups per active thiol group. In further embodiments, the number of isocyanate groups may be selected to react with all the thiol groups and less than 75, 50, 35, 25 or 10 percent of the hydroxyl groups in the composition comprising active molecules. The selection of the ratio of isocyanate groups to the active hydrogen groups depends on the properties desired for the resulting composition. For example, the ratio may be increased if needed to give more bonding, and thus higher viscosity, to the final composition. In contrast, if more hydroxyl groups are needed in the final composition for further reactions, the ratio may be decreased.

Generally, thiourethane compositions made using the present techniques will have thiourethane molecules having a greater number of hydroxyl groups than thiol groups and/or a greater number of thiourethane groups than urethane groups. For example, using the ratios discussed above, embodiments of the resulting composition may have R_{H/T} greater than about 1. In other embodiments, the ratio may be greater than 1.5, 2, 5, 10, 100, or 1000. Further, the ratio may be between 1.5 and 100,000, may be between 2 and 50,000, may be between 5 and 25,000 or may be between 20 and 10,000. Further, R_{T/U} may have analogous values, with embodiments having ratios greater than 1, 1.5, 2, 5, 10, 100, or 1000. As for R_{H/T}, R_{T/U} may be between 1.5 and 100,000, may be between 2 and 50,000, may be between 5 and 25,000 or may be between 20 and 10,000.

In practice, the selective formation of the thiourethane group in the using an amine catalyst may occur at any temperature which will allow the isocyanate to react selectively with a thiol group in the presence of a hydroxyl group. Suitable temperatures for the selective formation of the thiourethane group using an amine catalyst include temperatures ranging from 0° C. to 130° C., 15° C. to 110° C., 30° C. to 90° C., or 40° C. to 80° C.

The thiourethane compositions of the present techniques may be used as starting materials for producing other products, including adhesives and coatings, among others. For example, compositions made using the present techniques may be formed into one part of a two part coating or adhesive formulation, where the second part contains monomer molecules that may react with the hydroxyl groups to form bonds. Such monomer molecules may include isocyanates, or may include other molecules, such as epoxy groups or acid anhydrides, among others. The reaction of the first and second parts may be enhanced by the addition of a catalyst composition, as detailed below. The catalyst composition may be added to the first part, the second part, or to both or as a third part.

Specific components that may be used in embodiments of the present techniques are discussed in further detail in the sections that follow. Specifically, the first section details reactive compositions that contain active molecules having thiol and/or hydroxyl groups. The following section details monomer compositions that contain monomer molecules having isocyanate groups. The final section details solvents, catalysts and other components that may be used in embodiments of the present techniques.

Reactive Compositions that Include Thiol and Hydroxyl Groups

Reactive compositions that may be used in embodiments of the current techniques may include any combination of active molecules that contain hydroxyl and thiol groups. For example, the reactive composition may include one or more active molecules having both hydroxyl and thiol groups. Alternatively, the reactive composition may be made from a blend of active molecules having hydroxyl groups with active molecules having thiol groups. Generally, in embodiments, the reactive composition will average at least one hydroxyl group and at least one thiol group per active molecule. For example, the reactive composition may include a blend of active molecules having an average of two thiol groups per molecule with active molecules having an average of two hydroxyl groups per molecule. Further, the reactive composition may consist essentially of active molecules or may have other ingredients, including, for example, solvents, fillers, or other materials.

The reactive composition may include simple active molecules, such as, for example, the mercapto hydroxyl cyclohexane discussed with respect to the figures, above. These simple molecules may also include, for example, aliphatic or aromatic molecules having 1-20 carbons, 0-5 hydroxyl groups, and 0-5 thiol groups, among others. The simple molecules may also include aliphatic or aromatic molecules having 1-10 carbons, 0-3 hydroxyl groups, and 0-3 thiol groups. In embodiments, the simple active molecules will average at least one hydroxyl group per active molecule and at least one thiol group per active molecule. This is not to imply that all molecules have both thiol groups and hydroxyl groups. Indeed, simple active molecules having an average of two hydroxyl groups per molecule may be combined with molecules having an average of two thiol groups per molecule. One of ordinary skill in the art will recognize that similar molecules will function in the present techniques and are well within the scope.

Instead of, or in addition to, the molecules discussed above, the reactive composition may contain more complex active molecules, potentially having several thiol and/or hydroxyl groups per active molecule, as well as other functional groups. These molecules may include, for example, the reaction products of hydrogen sulfide with unsaturated esters and/or the reaction product of hydrogen sulfide with epoxized unsaturated esters. Depending on the starting materials, these molecules may include mercaptanized unsaturated esters, mercaptanized epoxidized unsaturated esters, crosslinked mercaptanized unsaturated esters, or combinations thereof. The unsaturated esters used as the starting material for the active molecules listed above have at least one ester group and at least one carbon-carbon double bond within the unsaturated ester molecule and may be obtained from natural sources or synthetically formed. These molecules, and the unsaturated esters used as feedstocks in forming these molecules, are described in detail below.

“Natural sources” refers to materials obtained, by any method, from naturally occurring or genetically modified fruits, nuts, vegetables, plants, and animals. As an example, natural source oil refers to unsaturated esters extracted, and optionally purified, from naturally occurring fruits, nuts, vegetables, plants, and animals. Alternatively, the unsaturated esters may be produced using a combination of materials from natural and synthetic sources. For example, the unsaturated esters may be produced by the reaction of synthetic ethylene glycol and oleic acid isolated from a natural source oil. Alternatively, the unsaturated esters may be produced from the reaction of glycerol isolated from natural source oils and a synthetic carboxylic acid, e.g. acrylic acid. Alternatively, the unsaturated esters may be produced from glycerol and oleic acid isolated from natural source oils.

The reactive composition used as a feedstock to produce the thiourethane compositions described herein may be described using a number of different methods, such as the type of functional groups present on the active molecules. For example, the reactive composition may contain active molecules having at least one ester group and at least one thiol group, referred to as a thiol ester. Alternatively, the active molecules in the reactive composition may include additional groups, such as hydroxyl groups, and/or polysulfide linkages —Sₓ— wherein x is an integer greater than 1. When the active molecules contain a hydroxy group, the thiol ester may be referred to as a hydroxy thiol ester. When the thiol ester has polysulfide linkages —Sₓ— wherein x is an integer greater than 1, the thiol ester may be referred to as a crosslinked thiol ester. When the thiol ester has a hydroxy group and a polysulfide group —Sₓ— wherein x is an integer greater than 1, the thiol ester may be referred to as crosslinked hydroxy thiol ester.

The active molecules in the reactive composition may also be described using a name that indicates the method by which they were formed. For example, an active molecule referred to as a mercaptanized unsaturated ester refers to a thiol ester produced by reacting hydrogen sulfide with an unsaturated ester. The mercaptanized unsaturated ester may be further described by the functional groups. For example, mercaptanized soybean oil may be alternatively described by a combination of the number of ester groups and the number of thiol groups present in the mercaptanized soybean oil.

The active molecules that may be used in reactive compositions of the present techniques may be produced by reacting any unsaturated ester with hydrogen sulfide, as described in U.S. patent application Ser. Nos. 11/060,675; 11/060,696; 11/059,792; and 11/059,647 (hereinafter “the '675 Applications”), each of which is incorporated herein by reference in its entirety. Because unsaturated esters may contain multiple carbon-carbon double bonds per unsaturated ester molecule, carbon-carbon double bond reactivity and statistical probability dictate that each mercaptanized unsaturated ester will not have the same number of thiol groups, number of cyclic sulfides, molar ratio of cyclic sulfides to thiol groups, and/or other quantities of functional groups and molar ratios disclosed herein as the unsaturated ester. Additionally, the unsaturated esters may also include a mixture of individual unsaturated esters having a different number of carbon-carbon double bonds and/or ester groups. Thus, many of these properties will be described as an average number of the groups per active molecule within the reactive composition.

Generally, the reactive compositions may be described as including the one or more separate or discreet functional groups of the active molecules. These independent functional groups may include: the number of (or average number of) ester groups per active molecule, the number of (or average number of) thiol groups per active molecule, the average thiol sulfur content of the reactive composition, the percentage (or average percentage) of sulfide linkages per active molecule, and the percentage (or average percentage) of cyclic sulfide groups per active molecule. Additionally, the reactive compositions may be described using individual or a combination of ratios including the ratio of double bonds to thiol groups, the ratio of cyclic sulfides to mercaptan groups, and the like. As separate elements, these functional groups of the reactive composition will be described separately.

The reactive composition may contain active molecules having an average of at least one ester group per active molecule. As the active molecules may be prepared from unsaturated esters, the active molecules may contain the same number of ester groups as the unsaturated esters from which they are prepared. In other examples, the active molecules may have an average of at least 1.5 ester groups per active molecule, an average of at least 2 ester groups per active molecule, an average of at least 2.5 ester groups per active molecule or an average of at least 3 ester groups per active molecule. Further, the thiol esters may have an average of from 1.5 to 8 ester groups per active molecule, an average of from 2 to 7 ester groups per active molecule, an average of from 2.5 to 5 ester groups per active molecule or an average of from 3 to 4 ester groups per active molecule.

The reactive composition may also contain active molecules having an average of at least one thiol group per active molecule. In other examples, the active molecules may have an average of at least 1.5 thiol groups per active molecule, an average of at least 2 thiol groups per active molecule, an average of at least 2.5 thiol groups per active molecule, or an average of at least 3 thiol groups per active molecule. Further, the active molecules may have an average of from 1.5 to 9 thiol groups per active molecule, an average of from 3 to 8 thiol groups per active molecule, an average of from 2 to 4 thiol groups per active molecule, or an average of from 4 to 8 thiol groups per active molecule.

Generally, the location of the thiol group within the active molecule may not be particularly important and will be dictated by the method used to produce the active molecule. For example, in embodiments wherein a thiol ester is produced by contacting an unsaturated ester with hydrogen sulfide, forming a mercaptanized unsaturated ester, the position of the thiol group will be dictated by the position of the carbon-carbon double bond. When the carbon-carbon double bond is an internal carbon-carbon double bond, the method of producing the thiol ester will result in a secondary thiol group. However, when the double bond is located at a terminal position it may be possible to choose reaction conditions to produce a thiol ester having either a primary thiol group or a secondary thiol group.

It should be noted that in curing reactions, a primary thiol group may react with an isocyanate group somewhat differently from a secondary thiol group in response to catalysts. However, the majority of thiol groups formed in the unsaturated esters is likely to be secondary, typically formed from carbon-carbon double bonds located away from the ends of the chains. Accordingly, if present at all, primary thiol groups are unlikely to be in high enough concentration to affect the preferential reaction of thiol groups under the influence of amine catalysts, as discussed above.

Some methods of producing the reactive composition may create sulfur containing functional groups other than a thiol group. For example, in some methods for producing thiol esters, more than one thiol group may react, producing a polysulfide linkage, or —S—S— group, connecting two carbon chains. When the subsequent thiol group reacts with the carbon-carbon double bond in a second ester group of the same unsaturated ester molecule, the sulfide may contain at least one ester group within a ring structure. Within this specification, this type of sulfide may be referred to as a simple sulfide. However, when the subsequent thiol group reacts with the carbon-carbon double bond within the same ester group, the sulfide does not contain an ester group within the ring structure. Within this specification, this type of sulfide may be referred to as a cyclic sulfide. The cyclic sulfide rings that may be produced include a tetrahydrothiopyran ring, a thietane ring, or a thiophane ring (tetrahydrothiophene ring).

It may desirable to control the average amount of sulfur present as cyclic sulfide in the active molecules. For example, the average amount of sulfur present as cyclic sulfide in the active molecules may be less than 30 mole percent, less than 20 mole percent, less than 10 mole percent, less than 5 mole percent or less than 2 mole percent. Further, it may be desirable to control the molar ratio of cyclic sulfides to thiol groups. For example, the average molar ratio of cyclic sulfide groups to thiol groups per thiol ester may be less than 1.5, less than 1, less than 0.5, less than 0.25 or less than 0.1.

In embodiments, the active molecules may include thiol esters made from natural source oils, as described herein. When the active molecules includes thiol esters made from natural source oils, functional groups that are present in the thiol esters may be described in a “per active molecule” basis or in a “per triglyceride” basis. The thiol esters may have substantially the same properties as the thiol ester composition, such as the molar ratios and other independent descriptive elements described herein. Generally, the average number of thiol groups per triglyceride in the thiol containing natural source oil may be greater than about 1.5, greater than about 2, or greater than about 2.5, and may range from about 1.5 to about 9, about 2 to about 7, or about 2.5 to about 5.

### Hydroxy Thiol Ester Composition

In an aspect, the reactive composition may include active molecules of a hydroxy thiol ester. The hydroxy thiol ester may be described using a number of methods. For example, the hydroxy thiol ester may be described by the types of functional groups present in the hydroxy thiol ester. In this functional description, the hydroxy thiol ester composition contains molecules having at least one ester group, at least one thiol group, and at least one hydroxy group. In other embodiments, the thiol ester composition may include thiol esters with and without additional groups, such as polysulfide linkages —Sₓ— wherein x is an integer greater than 1. When the thiol ester has a hydroxy group and a polysulfide linkage, the thiol ester may be referred to as crosslinked hydroxy thiol ester.

Alternatively, a hydroxy thiol ester may be described using a name that indicates the method by which it was formed. For example, a hydroxy thiol ester that is produced by reacting hydrogen sulfide with an epoxidized unsaturated ester may be called a mercaptanized epoxidized unsaturated ester. The mercaptanized epoxidized unsaturated ester may be further described utilizing the function descriptor of the hydroxy thiol ester present in the mercaptanized epoxidized ester. Compounds that fit the hydroxy thiol ester composition description do not always fit the mercaptanized epoxidized unsaturated ester description.

For example, mercaptanized castor oil may be described as a hydroxy thiol ester by virtue of having at least one ester group, at least one thiol group, and at least one hydroxy group. Mercaptanized castor oil, however, is not a mercaptanized epoxidized unsaturated ester, as it may be produced by contacting castor oil (which contains carbon-carbon double bonds and hydroxyl groups) with hydrogen sulfide. In contrast, a mercaptanized epoxidized castor oil may be a mercaptanized epoxidized unsaturated ester oil, formed by contacting hydrogen sulfide with epoxidized castor oil.

A hydroxy thiol ester molecule may be produced by reacting hydrogen sulfide with an epoxidized unsaturated ester as described in the '675 Applications. When the thiol ester is produced by this technique, the material produced may be called a mercaptanized epoxidized ester. In a mercaptanized epoxidized ester, hydroxyl groups and the thiol groups may on adjacent carbons, in which case the active hydrogen groups may be referred to as an α-hydroxy thiol group. Because the epoxidized unsaturated ester may contain multiple epoxide groups, epoxide group reactivity and statistical probability dictate that not all hydroxy thiol ester molecules will have the same number of hydroxyl groups, thiol groups, α-hydroxy thiol groups, sulfides, cyclic sulfides, molar ratio of cyclic sulfides to thiol groups, molar ratio of epoxide groups to thiol groups, molar ratio of epoxide groups to α-hydroxy thiol groups, weight percent thiol sulfur, and/or other disclosed quantities of functional groups and their molar ratios as the epoxidized unsaturated ester.

Accordingly, many of these properties will be discussed as an average number or ratio per hydroxy thiol ester molecule. It may be desirable to control the content of thiol sulfur present in the hydroxy thiol ester. Because it may be difficult to ensure that the hydrogen sulfide reacts with every epoxide group within the epoxidized unsaturated ester, certain hydroxy thiol ester molecules may have more or less thiol groups than other molecules. Thus, the weight percent of thiol groups may be stated as an average weight percent across all hydroxy thiol ester molecules.

In various embodiments of the present techniques, the reactive composition may include hydroxy thiol ester molecules that have an average of at least 1 ester group and an average of at least 1 α-hydroxy thiol group per molecule or an average of at least 1.5 ester groups and an average of at least 1.5 α-hydroxy thiol groups per hydroxy thiol ester molecule. Alternatively, the hydroxy thiol ester may include at least one ester, at least one thiol group, and at least one hydroxy group. Thus, the reactive composition may include hydroxy thiol ester molecules that have an average of at least 1.5 ester groups, an average of at least one thiol group, and an average of at least 1.5 hydroxyl groups per hydroxy thiol molecule.

A hydroxy thiol ester may be prepared from either an epoxidized unsaturated ester or an unsaturated ester. Thus, the hydroxy thiol ester may contain the same number of ester groups as the epoxidized unsaturated ester or unsaturated ester. For example, the hydroxy thiol ester molecules may have an average of at least 1.5 ester groups per hydroxy thiol ester molecule, an average of at least 2 ester groups per hydroxy thiol ester molecule, an average of at least 2.5 ester groups per hydroxy thiol ester molecule or an average of at least 3 ester groups per hydroxy thiol ester molecule. Further, the hydroxy thiol ester molecules may have an average of from 1.5 to 8 ester groups per hydroxy thiol ester molecule, an average of from 2 to 7 ester groups per hydroxy thiol ester molecule, an average of from 2.5 to 5 ester groups per hydroxy thiol ester molecule or an average of from 3 to 4 ester groups per hydroxy thiol ester molecule. In embodiments, the reactive composition may include hydroxy thiol ester molecules having an average of about 3 ester groups per hydroxy thiol ester molecule or an average of about 4 ester groups per hydroxy thiol ester molecule.

Hydroxy thiol ester molecules have at least one thiol group per hydroxy thiol ester molecule. For example, the hydroxy thiol ester molecules may have an average of at least 1.5 thiol groups per hydroxy thiol ester molecule, an average of at least 2 thiol groups per hydroxy thiol ester molecule, an average of at least 2.5 thiol groups per hydroxy thiol ester molecule or an average of at least 3 thiol groups per hydroxy thiol ester molecule. Further, the hydroxy thiol ester molecules may have an average of from 1.5 to 9 thiol groups per hydroxy thiol ester molecule, an average of from 3 to 8 thiol groups per hydroxy thiol ester molecule, an average of from 2 to 4 thiol groups per hydroxy thiol ester molecule or an average of from 4 to 8 thiol groups per hydroxy thiol ester.

Furthermore, the hydroxy thiol ester molecules have an average of at least 1 hydroxyl group per hydroxy thiol ester molecule. For example, the hydroxy thiol ester molecules may have an average of at least 1.5 hydroxyl groups per hydroxy thiol ester molecule, an average of at least 2 hydroxyl groups per hydroxy thiol ester molecule, an average of at least 2.5 hydroxyl groups per hydroxy thiol ester molecule or an average of at least 3 hydroxyl groups per hydroxy thiol ester molecule. Further, the thiol ester molecules may have an average of from 1.5 to 9 hydroxyl groups per hydroxy thiol ester molecule, an average of from 3 to 8 hydroxyl groups per hydroxy thiol ester molecule, an average of from 2 to 4 hydroxyl groups per hydroxy thiol ester molecule or an average of from 4 to 8 hydroxyl groups per hydroxy thiol ester molecule.

The number of hydroxyl groups may be stated as an average molar ratio of hydroxyl groups to thiol groups. The molar ratio of hydroxyl groups to thiol groups may be at least 0.25. For example, the molar ratio of hydroxyl groups to thiol groups may be at least 0.5, at least 0.75, at least 1.0, at least 1.25 or at least 1.5. Further, the molar ratio of hydroxyl groups to thiol groups may range from 0.25 to 2.0, from 0.5 to 1.5 or from 0.75 to 1.25.

The hydroxy thiol ester may have an average of at least 1 α-hydroxy thiol group per hydroxy thiol ester molecule. For example, the hydroxy thiol ester molecules may have an average of at least 1.5 α-hydroxy thiol groups per hydroxy thiol ester molecule, an average of at least 2 α-hydroxy thiol groups per hydroxy thiol ester molecule, an average of at least 2.5 α-hydroxy thiol groups per hydroxy thiol ester molecule or an average of at least 3 α-hydroxy thiol groups per hydroxy thiol ester molecule. Further, the hydroxy thiol ester molecules may have an average of from 1.5 to 9 α-hydroxy thiol groups per molecule, an average of from 3 to 8 α-hydroxy thiol groups molecule, an average of from 2 to 4 α-hydroxy thiol groups per molecule or an average of from 4 to 8 α-hydroxy thiol groups per molecule. In various embodiments, at least 20 percent of the total side chains may include the α-hydroxy thiol group. Alternatively, an α-hydroxy thiol group may be found in at least 40 percent of the total side chains, at least 60 percent of the total side chains, at least 70 percent of the total side chains or in at least 80 percent of the total side chains.

In various embodiments, the epoxidized unsaturated ester used in the synthesis of the hydroxy thiol ester may be produced from an epoxidized natural source oil. Because the natural source oils have particular numbers of ester groups, the hydroxy thiol ester will have about the same number of ester groups as the natural source oil. Other independent properties that are described herein may be used to further describe the hydroxy thiol ester.

In other embodiments, the epoxidized unsaturated ester used to produce the hydroxy thiol ester may produced from synthetic (or semi-synthetic) unsaturated ester oils. Because synthetic ester oils may be made with particular numbers of ester groups, the hydroxy thiol ester would have about the same number of ester groups as the synthetic ester oil. Other independent properties of the unsaturated ester, whether the unsaturated ester includes natural source or synthetic oils, may be used to further describe the hydroxy thiol ester composition.

Examples of suitable hydroxy thiol esters include but are not limited to mercaptanized epoxidized vegetable oils, mercaptanized epoxidized soybean oil, mercaptanized epoxidized castor oil and mercaptanized castor oil. Other suitable mercaptanized epoxidized esters are described in the '675 Applications and are to be considered within the scope of the present techniques.

### Cross-Linked Thiol Ester Compositions

In an aspect, the reactive compositions may include active molecules of a cross-linked thiol ester. Generally, the cross-linked thiol ester molecules are oligomers of thiol esters that are connected together by polysulfide linkages —Sₓ— wherein x is an integer greater than 1. As the cross-linked thiol ester may be described as an oligomer of thiol esters, the thiol esters may be described as the monomer from which the cross-linked thiol esters are produced. In embodiments, the cross-linked thiol ester may be produced from a mercaptanized unsaturated ester and may be called a cross-linked mercaptanized unsaturated ester. In other embodiments, the cross-linked thiol ester may be produced from a hydroxy thiol ester and may be called a crossed linked hydroxy thiol ester. In yet other embodiments, the crosslinked thiol ester may be produced from a mercaptanized epoxidized unsaturated ester and may be called a cross-linked mercaptanized epoxidized thiol ester.

The cross-linked thiol ester molecules may include a thiol ester oligomer having at least two thiol ester monomers connected by a polysulfide linkage having a structure —Sₓ—, wherein x is an integer greater than 1. In an aspect, the polysulfide linkage may be the polysulfide linkage —Sₓ—, wherein x is 2, 3, 4, or mixtures thereof. In other embodiments, x may be 2, 3 or 4. For example, the cross-linked thiol ester molecules may include a thiol ester oligomer having at least 3 thiol ester monomers connected by polysulfide linkages, at least 5 thiol ester monomers connected by polysulfide linkages, at least 7 thiol ester monomers connected by polysulfide linkages or at least 10 thiol ester monomers connected by polysulfide linkages. Further, the cross-linked thiol ester molecules may include a thiol ester oligomer having from 3 to 20 thiol ester monomers connected by polysulfide linkages, from 5 to 15 thiol ester monomers connected by polysulfide linkages or from 7 to 12 thiol ester monomers connected by polysulfide linkages.

The cross-linked thiol ester molecules may include both thiol ester monomers and thiol ester oligomers. For example, the cross-linked thiol ester composition may have a combined thiol ester monomer and thiol ester oligomer average molecular weight greater than 2,000, greater than 5,000 or greater than 10,000. Further, the cross-linked thiol ester composition may have a combined thiol ester monomer and thiol ester oligomer average molecular weight ranging from 2,000 to 20,000, from 3,000 to 15,000 or from 7,500 to 12,500. The thiol ester monomers and thiol ester oligomers may have a total thiol sulfur content greater than 0.5 weight percent, greater than 1 weight percent, greater than 2 weight percent or greater than 4 weight percent. Further, the thiol ester monomers and the thiol ester oligomers may have a total thiol sulfur content from 0.5 weight percent to 8 weight percent, from 4 weight percent to 8 weight percent or 0.5 weight percent to 4 weight percent.

### Unsaturated Esters

The unsaturated ester molecules used as a feedstock to produce some of the active molecules described above may be described using a number of different methods. For example, the unsaturated ester may be described by the number of ester groups and the number of carbon-carbon double bonds that are in each unsaturated ester oil molecule. Suitable unsaturated esters used to produce the reactive compositions described herein include at least 1 ester group and at least 1 carbon-carbon double bond. However, beyond this requirement, the number of ester groups and carbon-carbon double bonds contained within the unsaturated esters are independent elements and may be varied independently of each other. Thus, the unsaturated esters may have any combination of the number of ester groups and the number of carbon-carbon double bonds described separately herein. Suitable unsaturated esters may also contain additional functional groups such as hydroxyl, aldehyde, ketone, epoxy, ether, aromatic groups, and combinations thereof. For example, the unsaturated ester castor oil has hydroxyl groups in addition to carbon-carbon double bonds and ester groups. Other suitable unsaturated esters will be apparent to those of skill in the art and are to be considered within the scope of the present techniques.

The unsaturated ester molecules may include at least one ester group. For example, the unsaturated ester may include 2 ester groups, 3 ester groups or 4 ester groups. Further, the unsaturated ester molecules may include from 2 to 8 ester groups, from 2 to 7 ester groups or from 3 to 5 ester groups. In embodiments, the unsaturated ester may include from 3 to 4 ester groups.

The unsaturated ester may also include a mixture of unsaturated ester molecules. For a mixture, the number of ester groups is best described as an average number of ester groups per unsaturated ester molecule. For example, the unsaturated esters may have an average of at least 1.5 ester groups per unsaturated ester molecule, an average of at least 2 ester groups per unsaturated ester molecule, an average of at least 2.5 ester groups per unsaturated ester molecule or an average of at least 3 ester groups per unsaturated ester molecule. Further, the unsaturated esters may have an average of from 1.5 to 8 ester groups per unsaturated ester molecule, an average of from 2 to 7 ester groups per unsaturated ester molecule, an average of from 2.5 to 5 ester groups per unsaturated ester molecule or an average of from 3 to 4 ester groups per unsaturated ester molecule. In embodiments, the unsaturated esters may have an average of about 3 ester groups per unsaturated ester molecule or an average of about 4 ester groups per unsaturated ester molecule.

Unsaturated esters have at least one carbon-carbon double bond per unsaturated ester molecule. For example, the unsaturated ester may include at least 2 carbon-carbon double bonds, at least 3 carbon-carbon double bonds or at least 4 carbon-carbon double bonds. Further, the unsaturated ester may include from 2 to 9 carbon-carbon double bonds, from 2 to 4 carbon-carbon double bonds, from 3 to 8 carbon-carbon double bonds or from 4 to 8 carbon-carbon double bonds.

For mixtures of unsaturated ester molecules, or mixtures of unsaturated molecules derived from natural source oils, the number of carbon-carbon double bonds in the mixture may best be described as an average number of carbon-carbon double bonds per unsaturated ester molecule. For example, the unsaturated esters may have an average of at least 1.5 carbon-carbon double bonds per molecule, an average of at least 2 carbon-carbon double bonds per molecule, an average of at least 2.5 carbon-carbon double bonds per molecule or an average of at least 3 carbon-carbon double bonds per molecule. Further, the unsaturated esters may have average of from 1.5 to 9 carbon-carbon double bonds per unsaturated ester molecule, an average of from 3 to 8 carbon-carbon double bonds per molecule, an average of from 2 to 4 carbon-carbon double bonds per molecule or an average of from 4 to 8 carbon-carbon double bonds per molecule.

In addition to the number of ester groups and the number of carbon-carbon double bonds present in the unsaturated ester molecules, the disposition of the carbon-carbon double bonds in unsaturated ester molecules having 2 or more carbon-carbon double bonds may be a consideration. For example, where the unsaturated ester molecules have 2 or more carbon-carbon double bonds, the carbon-carbon double bonds may be conjugated. In another example, the carbon-carbon double bonds may be separated from each other by only one carbon atom. When two carbon-carbon double bonds are separated by a carbon atom having two hydrogen atoms attached to it, e.g. a methylene group, these carbon-carbon double bonds may be termed as methylene interrupted double bonds. In other molecules, the carbon-carbon double bonds may isolated, e.g. the carbon-carbon double bonds are separated from each other by 2 or more carbon atoms. Finally, the carbon-carbon double bonds may be conjugated with a carbonyl group.

The unsaturated ester utilized to produce the thiol ester utilized in aspects of the current techniques may be any unsaturated ester having the number of ester groups and carbon-carbon double bonds per unsaturated ester described herein. The unsaturated ester may be derived from natural sources, synthetically produced from natural source raw materials, produced from synthetic raw materials, produced from a mixture of natural and synthetic materials, or a combination thereof.

### Unsaturated Natural Source Oil

In embodiments of the present techniques, the unsaturated ester may be an unsaturated natural source oil. The unsaturated natural source oil may be a triglyceride derived from either naturally occurring or genetically modified nut, vegetable, plant, and animal sources. For example, the unsaturated natural source oil may be tallow, olive, peanut, castor bean, sunflower, sesame, poppy, seed, palm, almond seed, hazelnut, rapeseed, soybean, corn, safflower, canola, cottonseed, camelina, flaxseed, or walnut oil. From these choices, any one or any combinations of unsaturated natural source oils may be selected on the basis of the desired properties, cost or supply. For example, the natural source oil may be selected from the group consisting of soybean, rapeseed, canola, or corn oil. Castor bean oil may be selected due to a large available supply in some parts of the world. Soybean oil may be selected due to a low cost and/or abundant supply. Finally, other oils may be selected to provide appropriate properties in the final composition. For example, from the choices listed above, certain unsaturated natural source oils may be selected to minimize the number of methylene interrupted double bonds, as previously described, which may result in higher thiol group and/or hydroxyl group content.

### Synthetic Unsaturated Esters

In addition to, or instead of, natural source oils, synthetic unsaturated ester oils may used to produce the active molecules containing thiol groups, as discussed above. These synthetic unsaturated esters may be produced using any methods for producing an ester group known to those of ordinary skill in the art. For example, the term “ester group” indicates a moiety formed from the reaction of a hydroxy group with a carboxylic acid or a carboxylic acid derivative. Typically, the esters may be produced by reacting an alcohol (a hydrocarbon molecule containing an —OH group) with a carboxylic acid, transesterification of carboxylic acid ester with an alcohol, reacting an alcohol with a carboxylic acid anhydride, or reacting an alcohol with a carboxylic acid halide. The alcohol, unsaturated carboxylic acid, unsaturated carboxylic acid ester, unsaturated carboxylic acid anhydride raw materials for the production of the unsaturated ester oil may be derived from natural sources, synthetic sources, genetically modified natural sources or any combinations thereof.

The alcohols and the unsaturated carboxylic acids, unsaturated carboxylic acid esters or unsaturated carboxylic acid anhydrides used to produce the unsaturated esters used as a feedstock in various aspects of this invention are independent elements. That is, these elements may be varied independently of each other and thus, may be used in any combination to produce an unsaturated ester utilized a feedstock to produce the compositions described in this application or as a feedstock for the processes described in this application. For example, a polyol, i.e., a hydrocarbon molecule containing multiple hydroxyl groups, may be used to form molecules having multiple ester groups. A polyol used to produce the unsaturated ester oil may be any polyol or mixture of polyols capable of reacting with an unsaturated carboxylic acid, unsaturated carboxylic acid ester, carboxylic acid anhydride, or carboxylic acid halide under reaction conditions apparent to those of ordinary skill in the art.

The number of carbon atoms in the polyol may be varied. For example, the polyol used to produce the unsaturated ester may have from 2 to 20 carbon atoms, from 2 to 10 carbon atoms, from 2 to 7 carbon atoms or from 2 to 5 carbon atoms. Further, the polyol may be a mixture of polyols having an average of 2 to 20 carbon atoms, an average of from 2 to 10 carbon atoms, an average of 2 to 7 carbon atoms or an average of 2 to 5 carbon atoms.

The polyol used to produce an unsaturated ester may have any number of hydroxyl groups needed to produce an unsaturated ester as described herein. For example, the polyol may have 2 hydroxyl groups, 3 hydroxyl groups, 4 hydroxyl groups, 5 hydroxyl groups, 6 hydroxyl groups, or more. Further, the polyol may have from 2 to 8 hydroxyl groups, from 2 to 4 hydroxyl groups or from 4 to 8 hydroxyl groups.

The polyol used to produce an unsaturated ester may be a mixture of polyols. In this case, an average number of hydroxyl groups may be used to describe the mixture. For example, the mixture of polyols may have an average of at least 1.5 hydroxyl groups per polyol molecule, an average of at least 2 hydroxyl groups per molecule, an average of at least 2.5 hydroxyl groups per molecule, an average of at least 3.0 hydroxyl groups per molecule or an average of at least 4 hydroxyl groups per molecule. Further, the mixture of polyols may have an average of 1.5 to 8 hydroxyl groups per polyol molecule, an average of 2 to 6 hydroxyl groups per molecule, an average of 2.5 to 5 hydroxyl groups per molecule, an average of 3 to 4 hydroxyl groups per molecule, an average of 2.5 to 3.5 hydroxyl groups per molecule or an average of 2.5 to 4.5 hydroxyl groups per molecule.

Suitable polyols that may be used in embodiments of the present techniques include 1,2-ethanediol, 1,3-propanediol, 1,4-butanediol, 1,5-pentanediol, 1,6-hexanediol, dimethylolpropane, neopentyl glycol, 2-propyl-2-ethyl-1,3-propanediol, 1,2-propanediol, 1,3-butanediol, diethylene glycol, triethylene glycol, polyethylene glycol, dipropylene glycol, tripropylene glycol, polypropylene glycol, cyclohexanedimethanol, 1,3-dioxane-5,5-dimethanol, 1,4-xylylenedimethanol, 1-phenyl-1,2-ethanediol, trimethylolpropane, trimethylolethane, trimethylolbutane, glycerol, 1,2,5-hexanetriol, pentaerythritol, ditrimethylolpropane, diglycerol, ditrimethylolethane, 1,3,5-trihydroxybenzene, 1,4-xylylenedimethanol, 1-phenyl-1,2-ethanediol, or any combination thereof. Any single polyol or combination of these polyols may be selected, depending on cost, availability and the properties desired. For example, the polyol may be glycerol, pentaerythritol or a mixture thereof, which are both in large supply and have multiple hydroxyl groups.

The carboxylic acid component of the unsaturated ester oil may be any carboxylic acid or mixture of carboxylic acids that include a carbon-carbon double bond. Further, the carboxylic acid component may be any mixture of saturated carboxylic acid and unsaturated carboxylic acid that produces an unsaturated ester oil meeting the feedstock requirement described herein. Thus, the carboxylic acid or carboxylic acid mixture used to produce the synthetic unsaturated ester oil may be described as having an average number of a specified element per carboxylic acid.

For example, independent elements of the carboxylic acid include the average number of carboxylic acid groups per carboxylic acid molecule, the average number of carbon atoms present in the carboxylic acid, and the average number of carbon-carbon double bonds per carboxylic acid. Additional independent elements include the position of the double bond in the carbon chain and the relative position of the double bonds with respect to each other when there are multiple double bonds.

Specific carboxylic acids used to produce the unsaturated ester oil may have from 3 to 30 carbon atoms per carboxylic acid molecule. The carboxylic acid may be linear, branched or a mixture thereof. The carboxylic acid may also include additional functional groups including alcohols, aldehydes, ketones, and epoxides, among others. For example, suitable carboxylic acids that may be used as a component of unsaturated carboxylic acid composition may have from about 3 to about 30 carbon atoms, 8 to 25 carbon atoms or from 12 to 20 carbon atoms. Further, the carboxylic acids that include the unsaturated carboxylic acid composition may have an average of 2 to 30 carbon atoms, an average of 8 to 25 carbon atoms or an average of from 12 to 20 carbon atoms.

The carbon-carbon double bond may be located anywhere along the length of the molecule. For example, the double bond may be located at a terminal position or may be located at internal position. Further, the carboxylic acid or mixture of carboxylic acids may include both terminal and internal carbon-carbon double bonds. The double bond may also be described by indicating the number of substituents that are attached to the carbon-carbon double bond. For example, the carbon-carbon double bond may be mono-substituted, disubstituted, trisubstituted, tetrasubstituted, or a mixture of unsaturated carboxylic acids that may have any combination of monosubstituted, disubstituted, trisubstituted and tetrasubstituted carbon-carbon double bonds.

Suitable unsaturated carboxylic acids include acrylic, agonandoic, agonandric, alchornoic, ambrettolic, angelic, asclepic, auricolic, avenoleic, axillarenic, brassidic, caproleic, cetelaidic, cetoleic, civetic, coriolic, coronaric, crepenynic, densipolic, dihomolinoleic, dihomotaxoleic, dimorphecolic, elaidic, ephedrenic, erucic, gadelaidic, gadoleic, gaidic, gondolo, gondoleic, gorlic, helenynolic, hydrosorbic, isoricinoleic, keteleeronic, labellenic, lauroleic, lesquerolic, linelaidic, linderic, linoleic, lumequic, malvalic, mangold's acid, margarolic, megatomic, mikusch's acid, mycolipenic, myristelaidic, nervoic, obtusilic, oleic, palmitelaidic, petroselaidic, petroselinic, phlomic, physeteric, phytenoic, pyrulic, ricinelaidic, rumenic, selacholeic, sorbic, stearolic, sterculic, sterculynic, stillingic, strophanthus, tariric, taxoleic, traumatic, tsuduic, tsuzuic, undecylenic, vaccenic, vernolic, ximenic, ximenynic, ximenynolic, and combinations thereof. In further embodiments, suitable unsaturated carboxylic acids include oleic, palmitoleic, ricinoleic, linoleic, or any combinations thereof. Any of these acids, individually or in any combinations, may be chosen depending on availability or the properties desired for the final unsaturated ester composition. For example, combinations of these acids may be selected to form synthetic triglycerides when reacted when glycerol. The synthetic triglycerides may have a similar number of carbon-carbon double bonds as the natural triglycerides, and thus provide similar properies to the natural triglycerides discussed earlier.

The unsaturated ester may also be produced by transesterification of a simple ester of the carboxylic acid or mixture of carboxylic acids described herein with the polyol compositions described herein. Specifically, the simple ester may be a methyl ester, or ethyl ester of the carboxylic acid or mixture of methyl and ethyl esters of carboxylic acids. Alternatively, the simple carboxylic acid ester may be a methyl ester of the carboxylic acids described herein.

### Epoxidized Unsaturated Esters

In addition to the molecules described above, epoxidized unsaturated ester molecules may be used to produce ester molecules containing both thiol groups and hydroxyl groups, i.e., hydroxyl thiol esters, as described above. For example, the reaction of an epoxidized carbon-carbon double bond, i.e., an epoxy group, with hydrogen sulfide may be used to produce an α-hydroxy thiol group (i.e., a hydroxyl group and a thiol group on adjacent carbon atoms) as described previously. Generally, an epoxidized unsaturated ester may be obtained by epoxidizing any unsaturated ester described herein. The unsaturated ester oil may be derived from natural sources, synthetically produced from natural source raw materials, produced from synthetic raw materials, produced from a mixture of natural and synthetic materials, or a combination thereof.

An epoxidized unsaturated ester may have at least one epoxide group. For example, an epoxidized unsaturated ester may have at least 2 epoxide groups, at least 3 epoxide groups or at least 4 epoxide groups. Further, an epoxidized unsaturated ester may include, from 2 to 9 epoxide groups, from 2 to 4 epoxide groups, from 3 to 8 epoxide groups or from 4 to 8 epoxide groups.

A mixture of epoxidized unsaturated esters may be formed from the epoxidation reaction, which may be described by the average number of epoxide groups per epoxidized unsaturated ester molecule. For example, the epoxidized unsaturated esters may have an average of at least 1.5 epoxide groups per epoxidized unsaturated ester molecule, an average of at least 2 epoxide groups per molecule, an average of at least 2.5 epoxide groups per molecule or an average of at least 3 epoxide groups per molecule. Further, the epoxidized unsaturated esters may have an average of from 1.5 to 9 epoxide groups per epoxidized unsaturated ester molecule, an average of from 3 to 8 epoxide groups per molecule, an average of from 2 to 4 epoxide groups per molecule or an average of from 4 to 8 epoxide groups per molecule.

In embodiments of the present techniques, the epoxidized unsaturated ester may be an epoxidized unsaturated natural source oil. The unsaturated natural source oil may be a triglyceride derived from either naturally occurring or genetically modified nut, vegetable, plant or animal sources. For example, the epoxidized natural source oil may be tallow, olive, peanut, castor bean, sunflower, sesame, poppy, seed, palm, almond seed, hazelnut, rapeseed, canola, soybean, corn, safflower, cottonseed, camelina, flaxseed, or walnut oil. As previously discussed, any single oil or combination of oils may be selected from this list, depending on the desired cost, properties or availability.

Monomer Compositions that Include Isocvanate Groups

Generally, the monomer composition includes, or may consist essentially of, monomer molecules having at least one isocyanate group. In embodiments forming a polymer, the isocyanate composition may include monomer molecules having multiple isocyanate groups. The monomer composition may also include a mixture of monomer molecules. When the monomer composition includes a mixture of monomer molecules, the monomer molecules may have an average of at least 1.5 isocyanate groups per molecule, an average of at least 2 isocyanate groups per molecule, an average of at least 2.5 isocyanate groups per molecule or an average of at least 3 isocyanate groups per molecule. Further, the monomer molecules may have an average of from 1.5 to 12 isocyanate groups per molecule, an average of from 1.5 to 9 isocyanate groups per molecule, an average of from 2 to 7 isocyanate groups per molecule, an average of from 2 to 5 isocyanate groups per molecule or an average of from 2 to 4 isocyanate groups per isocyanate molecule. In embodiments, the isocyanate composition may include aliphatic isocyanates, cycloaliphatic isocyanates, aromatic isocyanates, or any combination thereof.

Aliphatic isocyanate monomer molecules that may be included in the monomer composition include, for example, n-butyl isocyanate, n-hexyl isocyanate, ethylene diisocyanate, 1,3-trimethylene diisocyanate, 1,4-tetramethylene diisocyanate, 1,6-hexamethylene diisocyanate, 1,7-heptamethylene isocyanate, 1,8-octamethylene diisocyanate, 1,9-nonamethylene diisocyanate, 1,10-decamethylene diisocyanate, 1,11-undecamethylene diisocyanate, 1,12-dodecamethylene diisocyanate, 2,2′-dimethylpentane diisocyanate, 2,2,4-trimethyl-1,6-hexamethylene diisocyanate, 2,4,4-trimethylhexamethylene diisocyanate, 1,6,11-undecane triisocyanate, 1,3,6-hexamethylene triisocyanate, 1,8-diisocyanato-4-(isocyanatomethyl)octane, 2,5,7-trimethyl-1,8-diisocyanato-5-(isocyanatomethyl)octane, or any combination thereof. The monomer composition may include any one type or any combination of these molecules, depending on the cost, availability and properties desired.

Cycloaliphatic isocyanate monomer molecules that may be included in the monomer composition include, for example, 1-isocyanato-2-isocyanatomethyl cyclopentane, 1,3-cyclohexane diisocyanate, 1,4-cyclohexane diisocyanate, 2,4-methylcyclohexane diisocyanate, 2,6-methylcyclohexane diisocyanate, 1,2-dimethylcyclohexane diisocyanate, 1,4-dimethylcyclohexane diisocyanate, isophorone diisocyanate (IPDI), 1-isocyanato-1-methyl-4(3)-isocyanatomethyl cyclohexane, 1,3-bis-(isocyanato-methyl) cyclohexane, 1,4-bis(isocyanato-methyl) cyclohexane, 2,4′-dicyclohexylmethane diisocyanate, 4,4′-dicyclohexylmethane diisocyanate (hydrogenated MDI, HMDI), 2,2′-dimethyldicyclohexylmethane diisocyanate, 4,4′-bis(3-methylcyclohexyl)methane diisocyanate, or any combination thereof. As discussed above, the monomer composition may include any one type or any combination of these molecules, depending on the cost, availability and properties desired.

Aromatic isocyanate monomer molecules that may be included in the monomer composition include, for example, 1,3-phenylene diisocyanate, 1,4-phenylene diisocyanate, 2,4-tolylene diisocyanate (TDI), 2,5-toluene diisocyanate 2,6-tolylene diisocyanate, tolylene-α,4-diisocyante, 1,3-xylylene diisocyanate, 1,4-xylylene diisocyanate, diethylphenylene diisocyanate, diisopropylphenylene diisocyanate, trimethylbenzene triisocyanate, α,α,α′,α′-tetramethyl-1,3-xylylene diisocyanate, α,α,α′,α′-tetramethyl-1,4-xylylene diisocyanate, mesitylene triisocyanate, benzene triisocyanate, 1,5-diisocyanato naphthalene, methylnaphthalene diisocyanate, bis(isocyanatomethyl)naphthalene, biphenyl diisocyanate, 2,4′-diphenylmethane diisocyanate, 4,4′-diphenylmethane diisocyanate (MDI), polymeric 4,4′-diphenylmethane diisocyanate (polymeric MDI, PMDI), 3,3′-dimethyl-diphenylmethane-4,4′-diisocyanate, bibenzyl-4,4′-diisocyanate, bis(isocyanatophenyl)ethylene, triphenylmethane triisocyanate, bis(isocyanatoethyl)benzene, bis-(isocyanatopropyl)benzene, bis(isocyanatobutyl) benzene, naphthalene triisocyanate, diphenylmethane-2,4,4′-triisocyanate, 3-methyldiphenylmethane-4,6,4′-triisocyanate, 4-methyldiphenyl-methane-3,5,2′,4′,6′-pentaisocyanate, tetrahydronaphthylene diisocyanate, or any combination thereof. As discussed above, the monomer composition may include any one type or any combination of these molecules, depending on the cost, availability and properties desired.

### Solvents, Catalysts, and Other Components

The compositions discussed above may contain numerous other materials to facilitate the reactions or the use of the compounds, or to adjust the properties of the final compositions. These additional components may include, for example, solvents, catalysts and property modification agents, among others. For example, a solvent may be added to the thiourethane polymer composition during synthesis or afterwards. The solvent may be useful in adjusting the viscosity of the thiourethane polymer composition. Some solvents may lower the viscosity of the thiourethane polymer composition to enable the composition to be applied more easily.

The solvent may be a hydrocarbon solvent, a halogenated hydrocarbon solvent, a ketone solvent, a carbonate solvent, an ester solvent, an ether solvent, or any combination thereof. For example, the solvent may include a C₄ to C₂₀ saturated hydrocarbon, a C₄ to C₁₀ saturated hydrocarbon, a C₆ to C₂₀ aromatic hydrocarbon, or a C₆ to C₂₀ aromatic hydrocarbon. Other solvents that may be used include a C₁ to C₁₅ halogenated hydrocarbon, a C₁ to C₁₀ halogenated hydrocarbon, a C₁ to C₅ halogenated hydrocarbon. Suitable solvents may also include a C₁ to C₁₀ ketone, a C₁ to C₅ ketone, a C₁ to C₁₀ carbonate, a C₁ to C₅ carbonate, a C₁ to C₁₀ ester, a C₁ to C₅ ester, a C₁ to C₁₀ ether; or a C₁ to C₅ ether.

Suitable saturated hydrocarbon solvents that may be utilized include, for example, pentane, n-hexane, hexanes, cyclopentane, cyclohexane, n-heptane, heptanes, n-octane, and petroleum distillate. Suitable aromatic hydrocarbon solvents that may be utilized include, for example, benzene, toluene, mixed xylenes, ortho-xylene, meta-xylene, para-xylene, and ethylbenzene. Suitable halogenated solvents that may be utilized include, for example, carbon tetrachloride, chloroform, methylene chloride, dichloroethane, trichloroethane, chlorobenzene, and dichlorobenzene. Suitable ketone solvents that may be utilized include, for example, acetone, and methyl ethyl ketone. Suitable carbonate solvents that may be utilized include, for example, dimethyl carbonate, diethyl carbonate, propylene carbonate, and glycerol carbonate. Suitable ester solvents that may be utilized include, for example, methyl acetate, ethyl acetate, and butyl acetate. Suitable ether solvents that may be utilized, either singly or in any combination, include, but are not limited to, dimethyl ether, diethyl ether, methyl ethyl ether, diethers of glycols (e.g. dimethyl glycol ether), furans, dihydrofuran, substituted dihydrofurans, tetrahydrofuran (THF), tetrahydropyrans, 1,3-dioxanes, and 1,4-dioxanes. Other suitable solvents will be apparent to those of ordinary skill in the art and are to be considered within the scope of the present techniques.

The properties of the polymer may be modified by including a property modifying agent within one of the compositions used to produce the polymer. In this instance, the polymer may be described as a reaction product of a reactive composition, a monomer composition, a catalyst, and a property modifying agent. For example, a polyol may be added to the reactive composition as the polymer is being prepared. Such polyols may include polypropylene glycol or ethylene glycol, among others. Further, oligomeric reagents may be used in embodiments where flexibility may be needed, such as when the thiourethane polymer composition is being used as an adhesive or a sealant. For example, an oligomeric polyol, polyether, polyester, polyamines, polyether esters, or a combination thereof may be added.

The property modifying agent may also be used to provide other properties, such as strength and adhesion to the polymers produced in accordance with embodiments of the present techniques. The property modifying agent may also include one or more active hydrogen groups. For example, suitable property modifying agents may include trifunctional oligomers, tackifiers, polybutadiene, polyether amines (such as Jeffamine® polymers), ethers, urea, di(hydroxyethyl)disulfide (DIHEDS), among others. The property modifying agent may be added either during synthesis of the polymer or added immediately preceding or during the reaction of the polymer with additional components to form a final coating or adhesive. If the property modifying agent contains an active hydrogen group and is added during synthesis, it is believed that the resulting prepolymer composition will have slightly different properties than if the property modifying agent containing an active hydrogen group is added afterwards.

Generally, the catalyst used to form the thiourethane (polymer, prepolymer, or other) by preferentially reacting thiol groups with the isocyanate groups includes an amine. Suitable amine catalyst may include a primary amine, a secondary amine, or a tertiary amine. For example, the catalyst used to produce the polymer may be a tertiary amine. The amine, be it tertiary or other, may be an aliphatic or aromatic amine. Suitable amines may include a polyetheramine, a polyalkylene amine, or a tertiary amine polyol (e.g. Jeffol® A-480). Other suitable amine catalysts include a polyamine comprising at least two amine groups. For example, the amine may be an amine derived from polypropylene glycol, a polyether amine, a polyalkylene amine or a tertiary amine polyol, or any combination thereof. The amine catalyst may also be a polyamine including at least two amine groups. In embodiments, the catalyst may be 1,8-diazabicyclo[5,4,0]undec-7-ene [DBU-CAS#6674-22-2]; 1,4-diazabicyclo[2.2.2]octane [DABCO-CAS#280-57-9]); or triethylamine.

In reacting the thiourethane polymer or prepolymer with another isocyanate monomer composition to form a final product, for example a coating or adhesive, the catalyst may be a metal catalyst, an amine catalyst, or mixture thereof. Examples of suitable metal catalyst include a tin catalyst a bismuth catalyst, an iron catalyst, a zinc catalyst, or any combination thereof. Suitable metal catalysts include organometal catalyst, e.g. an organotin catalyst. Suitable amine catalysts have been previously described and may be used without any limitation. For example, the catalyst may be an organo-tin compound, an polypropylene glycol based amine, and combinations thereof. In a tin compound catalyst embodiment, the tin compound may be dibutyl tin dilaurate. Further, any of the amine catalysts discussed above may be used, either alone or in any combination with the catalysts listed here. Other suitable catalysts will be apparent to those of skill in the art and are to be considered within the scope of the present techniques. If other reactive groups, such as, for example, phthalates or acid anhydrides, are used for forming a final product, other types of catalyst systems may be used. For example, an acid source may be used to catalyze the reaction of the hydroxyl groups to phthalates to form polyester compositions.

### EXAMPLES AND PROCEDURES

### Measuring the Infrared Spectrum

The infrared spectrum, shown in FIG. 1, was obtained using a PerkinElmer™ Spectrum One bench top Fourier transform infrared (FTIR) spectrometer using a zinc selenium (ZnSe) attenuated total reflectance (ATR) probe. A sample (3 drops of liquid) was placed on the ATR probe and 4 scans from 4000-650 cm-1 were averaged to yield the spectrum in FIG. 1.

### Measuring Reaction Curves by FTIR

The reaction curves shown in FIGS. 2-5 were measured by the following procedures. A 3-necked, round-bottomed flask having 24-40 ground glass joints was fitted with a magnetic stir bar, a dry nitrogen (N₂) inlet, a thermowell, a thermocouple connected to an appropriate temperature controller/readout, and a rubber septum for reagent addition.

A Mettler Toledo ReactIR™ 4000 infrared (IR) spectrometer was connected to a laptop computer for analysis control and to monitor reaction progress. An instrument probe was attached to the glassware setup using an o-ring fitted ground glass joint adapter. The instrument probe used a diamond window for light transmission, and had a seal constructed of gold, a body constructed of Hastelloy C-276, and an optical range of 4400-2150 cm-1, 1950-650 cm-1. The probe was positioned sufficiently far into the flask as to insure that the probe was submerged in the reaction medium once reagents were added to the reaction apparatus.

The reaction was then carried out by the following procedure. A slight dry nitrogen sweep was started through the reaction flask, regulated by means of a mineral oil bubbler. The selected solvent was added (if desired) to the flask via a dry syringe through the rubber septum. In this case, anhydrous toluene was chosen, and the mixtures were conducted as 50% by weight solvent. The n-butyl isocyanate was added to the flask via a dry syringe through the septum. The isocyanate was used at sufficient level to provide a 10:1 mole ratio of isocyanate group to alcohol, or thiol group. To 20.0 g of anhydrous toluene was added 18.73 g of n-butyl isocyanate. To the resulting mixture 1.25 g of 1-hydroxy-2-mercapto cyclohexane was added, followed by the addition of the desired amount of catalyst or mixture of catalysts. This was to yield results that approximate pseudo-first order rate constants. The 1-hydroxy-2-mercapto cyclohexane was added to the reaction mixture by a dry syringe through the septum, after which, the ReactIR instrument was started and spectra, from 4000-600 cm-1, were recorded every 10 seconds until the reaction deemed complete. The desired catalyst was added to the mixture via a dry syringe through the septum. For the reactions shown in FIGS. 2 and 3, 0.02 g of a tin catalyst (dibutyltin dilaurate) was used and the reaction was run at 30° C. For the reactions shown in FIGS. 4 and 5, 0.04 g of an amine (tertiary amine mixture, triethylamine TEA) was used for the process and the reaction was run at 60° C. The IR spectra were recorded until the reaction was deemed complete by the operator.

While the techniques presented herein may be susceptible to various modifications and alternative forms, specific embodiments have been shown by way of example in the drawings and have been described in detail herein. However, it should be understood that the invention is not intended to be limited to the particular forms presented. Rather, the invention is to cover all modifications, equivalents and alternatives falling within the spirit and scope of the invention as defined by the following appended claims.

What is claimed is:

1. A composition comprising the contact product of contact elements comprising:
a reactive composition comprising active molecules having an average of at least one thiol group per active molecule, and an average of at least one hydroxyl group per active molecule, wherein each active molecule has at least one thiol group, or at least one hydroxyl group, or both;
a monomer composition comprising monomer molecules having an average of at least two isocyanate groups per monomer molecule; and
an amine catalyst;
wherein the contact product comprises molecules having a normalized average number of hydroxyl groups per molecule that is greater than a normalized average number of thiol groups per molecule, and wherein a normalized average number of thiourethane groups in the contact product is greater than a normalized average number of urethane groups.

2. The polymer of claim 1, wherein a ratio of the normalized average number of hydroxyl groups per polymer molecule to the normalized average number of thiol groups per polymer molecules in the polymer is greater than about 2:1.

3. The polymer of claim 1, wherein a ratio of the normalized average number of thiourethane groups per molecule to the normalized average number of urethane groups in the contact product is greater than about 2:1.

4. The polymer of claim 1, wherein the reactive composition comprises active molecules formed from an unsaturated ester, the active molecules comprising a mercaptanized unsaturated ester, a mercaptanized epoxidized unsaturated ester, a crosslinked mercaptanized unsaturated ester, or a hydroxyl thiol ester, or any combination thereof.

5. The polymer of claim 4, wherein the unsaturated ester comprises a tallow oil, an olive oil, a peanut oil, a castor bean oil, a sunflower oil, a sesame oil, a poppy seed oil, a palm oil, an almond seed oil, a hazelnut oil, a rapeseed oil, a canola oil, a soybean oil, a corn oil, a safflower oil, a cottonseed oil, a camelina oil, a flaxseed oil, or a walnut oil, or any combination thereof.

6. The polymer of claim 4, wherein the unsaturated ester comprises a synthetic unsaturated ester.

7. The polymer of claim 1, wherein the monomer molecules comprise aliphatic isocyanates having an average of at least two isocyanate groups per molecule, cycloaliphatic isocyanates having an average of at least two isocyanate groups per molecule, or aromatic isocyanates having an average of at least two isocyanate groups per molecule, or any combination thereof.

8. A method for selectively forming thiourethane groups, comprising:
forming a mixture comprising:
a reactive composition comprising active molecules having an average of at least one thiol group per active molecule and an average of at least one hydroxyl group per active molecule;
a monomer composition comprising monomer molecules having an average of at least at least one isocyanate group per monomer molecule; and
an amine catalyst; and
allowing the mixture to react to form a final composition comprising molecules having a normalized average number of thiourethane groups per molecule that is greater than a normalized average number of urethane groups per molecule, and having a normalized average number of hydroxyl groups per molecule that is greater than a normalized average number of thiol groups per molecule.

9. The method of claim 8, wherein a ratio of a number of isocyanate groups to the sum of the number of thiol groups and hydroxyl groups in the mixture is between about 0.1:1 and about 1:1.

10. The method of claim 8, wherein a ratio of a number of isocyanate groups to the sum of the number of thiol groups and hydroxyl groups in the mixture is between about 0.1:1 and about 0.5:1.

11. The method of claim 8, wherein a ratio of a number of isocyanate groups to the sum of the number of thiol groups and hydroxyl groups in the mixture is between about 0.1:1 and 0.25:1.

12. The method of claim 8, wherein the final composition has a ratio of the normalized average number of hydroxyl groups to the normalized average number of thiol groups of greater than about 2:1.

13. The method of claim 8, wherein a ratio of the normalized average number of thiourethane groups per molecule to the normalized average number of urethane groups per molecule in the mixture is greater than about 2:1.

14. The method of claim 8, wherein forming the mixture comprises adding a solvent.

15. The method of claim 14, wherein wherein the solvent comprises methyl ethyl ketone, glycerol carbonate, acetone, hexane, heptane, petroleum distillate, butyl acetate, toluene, or benzene, or any combination thereof.

16. A composition comprising molecules having thiourethane groups and hydroxyl groups, wherin the molecules have a normalized average number of hydroxyl groups per molecule that is greater than a normalized average number of thiol groups per molecule.

17. The composition of claim 16, wherein a ratio of the normalized average number of thiourethane groups per molecule to a normalized average number of urethane groups per molecule in the composition is greater than about 1:1.

18. A formulation for a coating or adhesive, comprising:
a first part comprising thiourethane molecules having thiourethane groups and hydroxyl groups, wherein a ratio of a number of hydroxyl groups per thiourethane molecule to a number of thiol groups per thiourethane molecule is greater than about 1:1; and
a second part comprising monomer molecules having an average of at least two reactive groups per monomer molecule, wherein the reactive groups can react with the hydroxyl groups to form bonds.

19. The formulation of claim 18, wherein a ratio of the number of hydroxyl groups to the number of thiol groups in the compound is greater than about 2:1.

20. The formulation of claim 18, comprising a catalyst composition comprising a metal catalyst, or an amine catalyst, or a combination thereof, wherein the catalyst composition is included in the first part, is included in the second part, or is provided as a third part, or any combination thereof.

21. The formulation of claim 18, wherein the reactive groups comprise isocyanate groups.

22. The formulation of claim 18, wherein the reactive groups comprise acid groups, acid anhydride groups, epoxy groups, phthalate groups, or isocyanate groups.

23. The formulation of claim 18, wherein the first part, the second part, or both, comprise a solvent.

24. The formulation of claim 23, wherein the solvent comprises methyl ethyl ketone, glycerol carbonate, acetone, hexene, petroleum distillate, butyl acetate, toluene, benzene, or any combination thereof.

25. A method of making a formulation for a coating or adhesive, comprising:
providing a first part comprising molecules having thiourethane groups and hydroxyl groups, wherein a normalized average number of hydroxyl groups per molecule is greater than a normalized average number of thiol groups per molecule; and
providing a second part comprising monomer molecules having an average of at least two reactive groups per monomer molecule, wherein the reactive groups can react with the hydroxyl groups to form bonds.

26. The method of claim 25, comprising providing a catalyst composition comprising a metal catalyst, or an amine catalyst, or a combination thereof, wherein the catalyst composition is included in the first part, is included in the second part, or is provided as a third part, or any combination thereof.

27. A formulation for a coating or adhesive, comprising:
a first part comprising a compound having thiourethane groups and hydroxyl groups, wherein a normalized average number of hydroxyl groups is greater than a normalized average number of thiol groups; and
a second part comprising monomer molecules having an average of at least two reactive groups per monomer molecule, wherein the reactive groups can react with the hydroxyl groups to form bonds.
